(19) United States
(12) Patent Application Publication
(10) Pub. No.: US 2024/0054369 A1
(43) Pub. Date: Feb. 15, 2024

(54) AI-BASED SELECTION USING CASCADED MODEL EXPLANATIONS

(71) Applicant: Bank of America Corporation, Charlotte, NC (US)

(72) Inventors: Melissa Podrazka, Chicago, IL (US); Justin Horowitz, Fort Mill, SC (US)

(21) Appl. No.: 17/883,784

(22) Filed: Aug. 9, 2022

(51) Int. Cl. G06N 5/04; G06N 20/00

(52) U.S. Cl. CPC G06N 5/045; G06N 20/00

(57) ABSTRACT

Apparatus and methods for harnessing an explainable artificial intelligence system to execute computer-aided feature selection is provided. Methods may receive an AI-based model. The AI-based model may be trained with a plurality of training data elements. The AI-based model may identify a set of features from the training data elements. The AI-based model may execute with respect to a first input. Methods may use a cascade model with integrated gradients to identify a feature importance value for each of the plurality of features included in the training data. Based on the feature importance value identified for each feature, methods may determine a feature importance metric level. Based on the feature importance value identified for each feature, methods may remove features that are assigned a value lower than the feature importance metric level. This removal may be implemented to form a revised AI-based model. Methods may execute the revised AI-based model.

### FIELD OF TECHNOLOGY

Aspects of the disclosure relate to explainable artificial intelligence (“AI”).

### BACKGROUND OF THE DISCLOSURE

Machine learning modeling typically requires human experts to compile a large variety of data aspects (i.e., features/variables/attributes) that may help to describe a particular phenomenon of interest. These data aspects are used by a machine learning model to predict a given outcome.

It should be noted that many of these data aspects, also referred to herein as features, may positively impact machine learning systems. However, not all of these data aspects positively impact the machine learning systems. At times, some of the features may be redundant. Furthermore, some of these data aspects may even hinder the model because of a phenomenon known as overfitting.

Overfitting is a concept in data science which occurs when a statistical model fits exactly against its training data. As such, the model considers noise, or irrelevant information, included in the training data. When overfitting occurs, the algorithm may fail to accurately classify an unclassified data element.

To remove these negatively impacting features, modelers usually utilize an iterative human process, known as feature selection. Feature selection identifies and selects the data aspects that provide the most positive impact.

One or more hyperparameters may be used in the feature selection process. A hyperparameter may be a parameter whose value is used to control the learning process. Selected hyperparameter may indicate choices about modeling which are outside model parameters. Hyperparameter may also require data in order to be optimized. It should be noted, however, that hyperparameters may also increase the chances of overfitting.

Both model parameters and hyperparameters may increase the possibility of overfitting. Furthermore, a model's quality may suffer when there is a relatively small amount of labeled training data. A relatively small amount of labeled training data elements may be used when data labels are costly to obtain or only a few labeled data elements are available. Human-based feature selection may inaccurate specifically with small amounts of training data. Also, human-based feature selection may be resource-consuming, iterative and lengthy. Therefore, it would be desirable for automated feature selection.

One popular method called “autoencoders” use unlabeled data to find a neural network-based latent representation of the underlying data aspects. As these neural networks are opaque and nearly unexplainable, an enterprise can only use them under certain circumstances. Moreover, artificial intelligence explainability concerns are increasingly widespread. It would be desirable to leverage artificial intelligence explainability to go beyond traditional human attributions of which data aspects are important to computer-aided attributions of which data aspects are both good and important.

Therefore, it would be desirable to utilize the Shapley Value explanation method for a given model prediction that is explainable. Shapley Values optimization utilizes a collaborative contest where players are associated with the outcome of the contest. SHAP (Shapley additive exPlanations) by Lundberg and Lee is based on the Shapley Values optimization. When using SHAP in AI, the outcome of the contest is the prediction, and the players are the various features inputted to determine the prediction. The result of SHAP is similar to feature importance. SHAP can be explained as optimized aggregations of Shapley values. As such, SHAP provides a solution for identification of a single most important input.

Additionally, each input element may be assigned an explanation value such that the sum of the explanations is the prediction, and the prediction is fair. To form these values, algorithms, such as SHAP, TreeSHAP and Integrated Gradients can be used.

In co-pending, commonly assigned U.S. patent application Ser. No. 17/541,428 filed on Dec. 3, 2021, entitled RESOURCE CONSERVATION SYSTEM FOR SCALABLE IDENTIFICATION OF A SUBSET OF INPUTS FROM AMONG A GROUP OF INPUTS THAT CONTRIBUTED TO AN OUTPUT which is hereby incorporated by reference herein in its entirety, a method for explaining multistage models has been identified. It would be desirable to utilize multistage modeling to explain a model and then cascade its explanation into a second layer. It would be desirable for the second layer to suggest the model's error or cost. As such, it would be desirable for a multi-stage model cascade to identify, for each feature, whether the feature is important, and to determine a good or bad impact for each feature within the scope of the model.

### SUMMARY OF THE DISCLOSURE

For some models, AI explainability may operate at a considerably faster speed than a typical modeling process. A typical modeling process may include selecting data and features and building a model from the selected data and features. The typical modeling process also includes tuning the model. Tuning the model may include tuning selected data and features by removing data, adding more data, removing features, adding more features, assigning more importance to certain features and removing some importance from other features. Tuning the model is typically an iterative, manual process.

AI explainability is the sector of data science that enables a human to understand a machine learning process. AI explainability includes being able to explain each of the processes and data elements that go into a machine learning process. Additionally, various mathematical equations have been written and deployed that attribute the outcome of a process to the important inputs. As noted above, an AI explainability algorithm that attributes the outcome of a process to the important inputs may operate considerably faster than a typical modeling process.

As such, apparatus and methods for AI-based feature selection using cascaded model explanations is provided. The AI-based features selection system may select data and features for a model. The AI-based feature selection system may execute the model one time. The AI-based feature selection system may generate an explanation of each of the features of the executed model. The AI-based feature selection system may use the explanation to select only important features that improve the model's outcome. The system can then execute the model a second time with the selected features.

As such, model processing using explanation to remove unnecessary features may utilize two passes to deliver a highly calibrated model, as opposed to conventional feature selection which may be an iterative, lengthy and costly process.

Multi-stage modeling (cascade modeling) discussed in U.S. patent application Ser. No. 17/541,428 specified above, establishes a relationship between feature importance and feature impact. Therefore, features that have a negative impact may be removed from the model. Furthermore, features that don't have a large enough positive impact may also be removed from the model.

Explanation of model outputs may identify important outputs. Cascading outputs into secondary factors such as cost or error may identify model components leading to the cost and error. Therefore, non-important and harmful features can be removed. In certain embodiments, this process can be iterated until there is no net source of cost or error. Every feature must improve the model more than impairs the model to justify its place within the model.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative computer code in accordance with principles of the disclosure;

FIG. 2A shows an illustrative diagram in accordance with principles of the disclosure;

FIG. 2B shows illustrative computer code in accordance with principles of the disclosure;

FIG. 3A shows an illustrative diagram in accordance with principles of the disclosure;

FIG. 3B shows illustrative computer code in accordance with principles of the disclosure;

FIG. 3C shows an illustrative diagram in accordance with principles of the disclosure;

FIG. 4 shows illustrative computer code in accordance with principles of the disclosure;

FIG. 5 shows illustrative computer code in accordance with principles of the disclosure;

FIG. 6A shows illustrative computer code in accordance with principles of the disclosure; and

FIG. 6B shows illustrative computer code in accordance with principles of the disclosure.

### DETAILED DESCRIPTION OF THE DISCLOSURE

Apparatus and methods for a computing resource conservation system is provided. The system may include a priming model module. The priming model module may operate on a hardware processor and a memory. The priming model module may receive a training data set. The training data set may include a plurality of data element sets and a predetermined label associated with each of the data element sets.

The priming model module may identify a plurality of features that characterize a data element as being associated with the predetermined label. The priming model module may create an AI-model. The priming model may use the plurality of features to create the AI-model. The AI-model may characterize an unlabeled data element set as being associated with the predetermined label.

The system may include a refining model module. The refining model module may operate on the hardware processor and the memory. The refining model module may assign, using an algorithm, a value to each feature included in the plurality of features. The algorithm may be Integrated Gradients, Cascaded Integrated Gradients, SHAP or Tree SHAP.

The refining model module may remove, from the AI-model, features that have been assigned a value that is less than a predetermined threshold. The predetermined threshold may correspond to a percentage of the plurality of features. The predetermined threshold may also correspond to a predetermined number of the plurality of features. The predetermined threshold may also correspond to a predetermined value assigned to the plurality of features. The predetermined threshold may correspond to a negative value. The predetermined threshold may correspond to a combination of the percentage of the plurality of features, a predetermined number of the plurality of features, a predetermined value assigned to the plurality of features and/or a negative value.

The refining model module may recreate the revised AI-model. The revised AI-model may be able to characterize an unlabeled data element set as being associated with the predetermined label. The refining model module may be re-executed until all of the features are assigned a value that is greater than the predetermined threshold.

A method for harnessing an explainable artificial intelligence system to execute computer-aided feature selection is provided. The method may include receiving an AI-based model. The AI-based model may be trained with a plurality of training data elements. The AI-based model may identify a plurality of features from the plurality of training data elements. The AI-based model may execute with respect to a first input.

The method may include using the cascade of models with integrated gradients to identify a feature importance value for each of the plurality of features. The method may include determining a feature importance metric level. The determination of the feature importance metric level may be based on the feature importance value identified for each feature.

The method may include removing one or more features. The removal of the features may be based on the feature importance value identified for each feature. As such, features that are assigned a feature importance value that is less than the feature importance metric level may be removed from the plurality of features. The removal of the features may form a revised AI-based model. The method may include executing the revised AI-based model with respect to a second input.

A method for harnessing an explainable artificial intelligence system to execute computer-aided feature selection may be provided. The method may utilize two or more iterations.

On a first iteration, the method may include receiving a characterization output characterizing a first data structure. The method may also include identifying a plurality of data elements associated with the first data structure. The method may also include feeding the plurality of data elements into one or more models. The method may also include processing the plurality of data elements at the one or more models. The method may also include identifying a plurality of outputs from the one or more models.

In some embodiments, upon identification of the plurality of outputs from the one or more models, the method may include determining a probability of the first data structure being associated with the characterization output. The determination may be executed by a determination processor.

In certain embodiments, the method may also include feeding the plurality of outputs into an event processor. The method may include processing the plurality of outputs at the event processor. The method may also include grouping the plurality of outputs into a plurality of events at the event processor. The method may also include inputting the plurality of events into a determination processor. The method may include determining a probability of the first data structure being associated with the characterization output. The determination may be executed by a determination processor.

A predetermined number of data elements may be removed from the plurality of data elements. The predetermined number of data elements that are removed may negatively impact the characterization output. In order to remove the predetermined number of data elements, the method may include multiplying the integrated gradient of the determination processor with respect to the plurality of outputs by (the integrated gradient of the event processor with respect to the plurality of data elements divided by the plurality of outputs). The result of the multiplication may include a vector of a subset of the plurality of data elements and a probability that each data element, included in the subset of data elements, contributed to the characterization output.

The equation for determining the integrated gradient may be shown as Equation A.

$${IG}_{W} ( x ) = {\int }_{{t}_{0}}^{{t}_{f}} \frac{\partial W}{\partial x} \frac{dx}{dt} d t \qquad Equation A$$

In certain embodiments, the method may include multiplying the integrated gradient of the one or more models with respect to the plurality of outputs by (the integrated gradient of the one or more models with respect to the plurality of data elements divided by the plurality of outputs). The result of the multiplication may include a vector of a subset of the data elements and a probability that each data element, included in the subset of data elements, contributed to the characterization output.

The method may also include removing one or more data elements from the subset of the plurality of data elements. The removed data elements may be associated with a probability that is less than a probability threshold.

On a second iteration, the method may include re-feeding the updated subset of the plurality of data elements into the one or more models. The method may include re-processing the plurality of data elements at the one or more models. The method may include re-identifying a plurality of outputs from the one or more models. The method may include re-feeding the plurality of outputs into the event processor.

The method may include re-processing the plurality of outputs at the event processor. The method may include re-grouping the plurality of outputs into the plurality of events at the event processor. The method may include re-inputting the plurality of events into the determination processor. The method may include re-determining, at the determination processor, the probability of the first structure being associated with the characterization output. It should be noted that the probability of the second iteration compared to the probability of the first iteration may be a greater probability because the model may be more accurate because of the removal of the negatively impacting features. The methods may include utilizing the one or more models to characterize unlabeled data elements.

At times, the steps included in the first iteration may be re-executed until all of the data elements are assigned a probability that is greater than the probability threshold.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

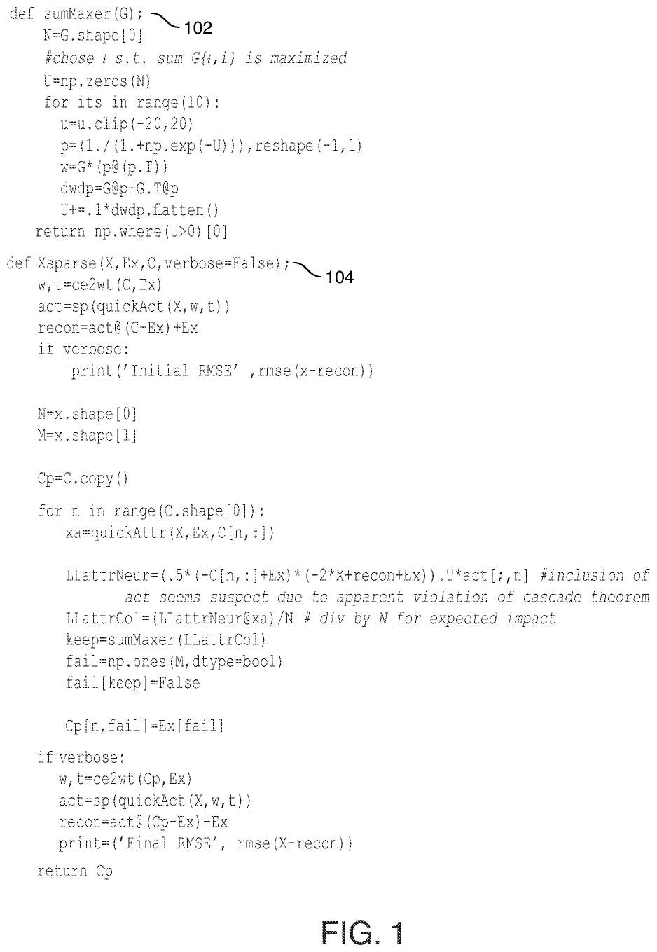

FIG. 1 shows illustrative computer code. The illustrative computer code shows a sumMaxer method, shown at 102. The illustrative computer code also shows an Xsparse method, shown at 104. The sumMaxer method 102 may include selecting an i variable in which the sum is maximized.

The Xsparse method, shown at 104, may show identifying the value for each feature included within a set of features. Furthermore, the Xsparse method may remove features, from the set of features, that negatively impact the output. The remaining features may positively impact the model.

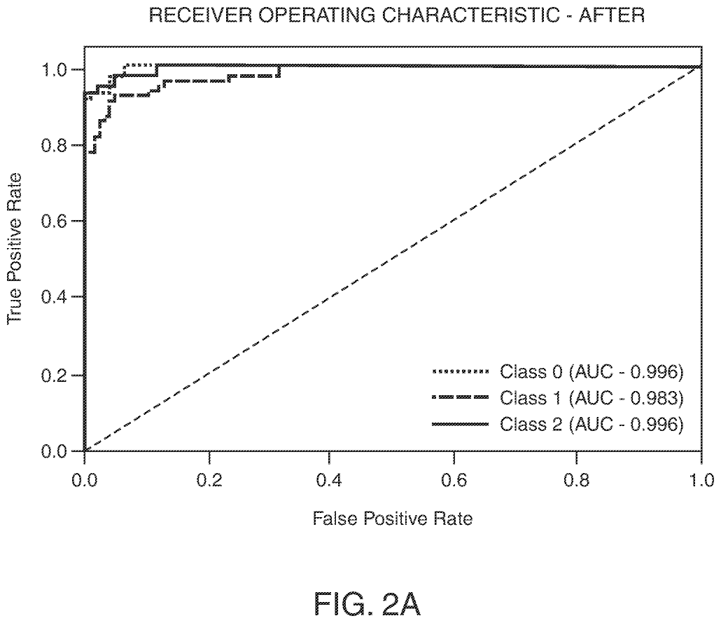

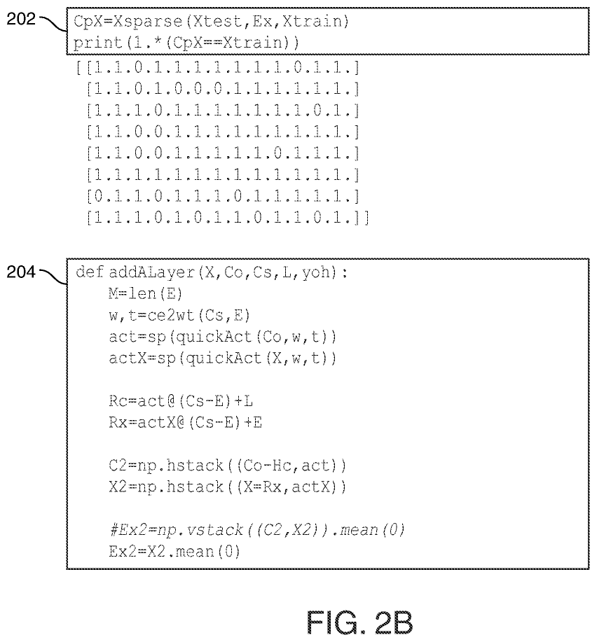

FIG. 2A shows an illustrative diagram. The illustrative diagram shows a graphical representation of a model after the Xsparse method has been used to select features for the model. It should be noted that the AUC (area under the curve) ranges between 0.983 and 0.996.

FIG. 2B shows illustrative computer code. The illustrative computer code includes a printout of the execution of an Xsparse method, as shown at 202. The illustrative computer code also includes a method named addALayer. The method addALayer may be operable to add a layer to an underlying neural network.

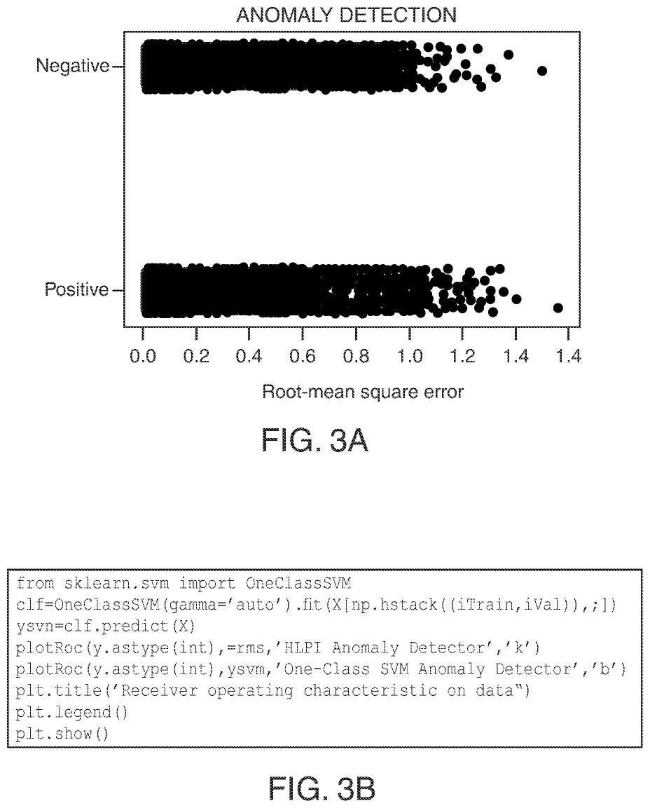

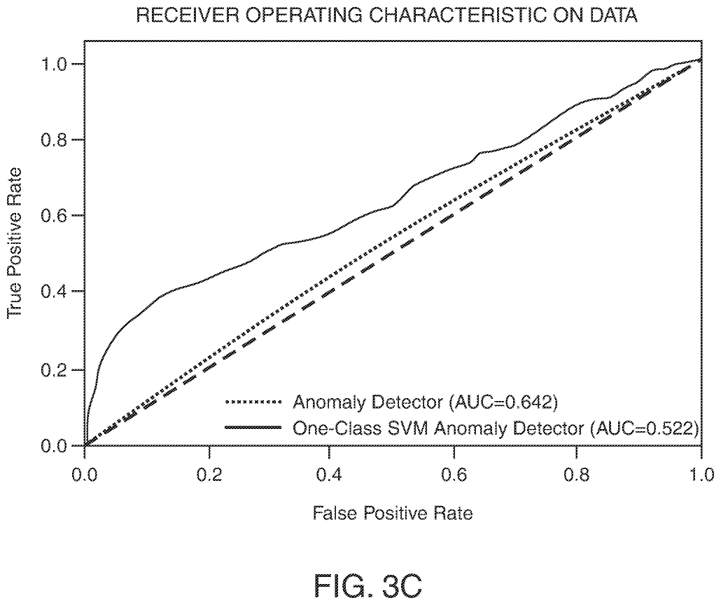

FIG. 3A shows an illustrative diagram. The illustrative diagram shows a first use of the Xsparse method. The first use case may include anomaly detection.

The Xsparse method may be used to identify whether a data element is or is not associated with an anomaly. Root-mean-square error (RMSE) may be used to identify negative data elements vs. positive data elements. Negative data elements may not be associated with the anomaly and positive data elements may be associated with the anomaly.

FIG. 3B shows illustrative computer code. The illustrative computer code shows the code used to produce the graph shown in FIG. 3C.

FIG. 3C shows an illustrative diagram. The illustrative diagram shows a graph of receiver operating characteristics on data. The AUC (area under the curve) for the anomaly detector is 0.642 and the AUC (area under the curve) for the one-class SVM (support vector machine) anomaly detector is 0.522.

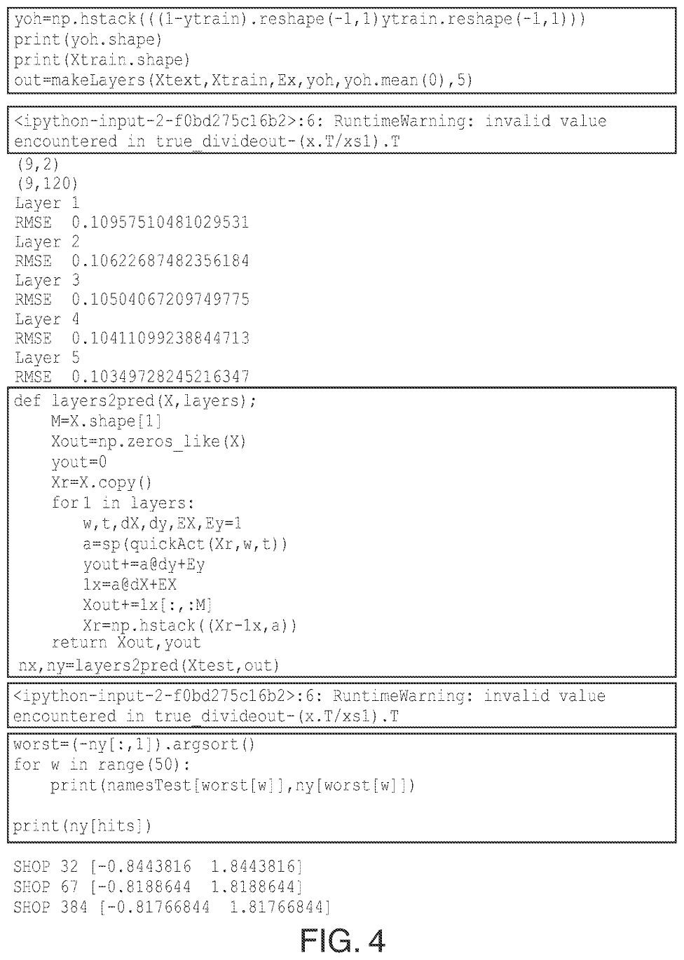

FIG. 4 shows illustrative computer code. The illustrative computer code shows identifying one or more enterprises that are associated with suspicious activity. It should be noted that illustrative shops 32, 67 and 384 have been identified as having the highest suspicious activity in New York.

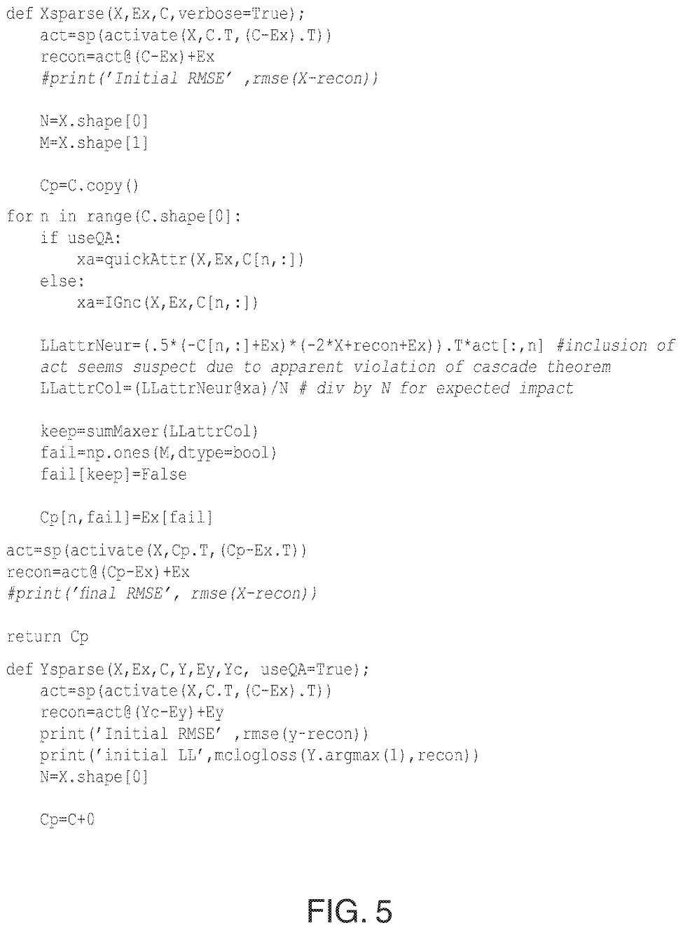

FIG. 5 shows illustrative computer code. The illustrative computer code shows processing the Xsparse method and a Ysparse method. The Ysparse method may remove unnecessary or negatively impacting data elements and/or features from the machine learning process.

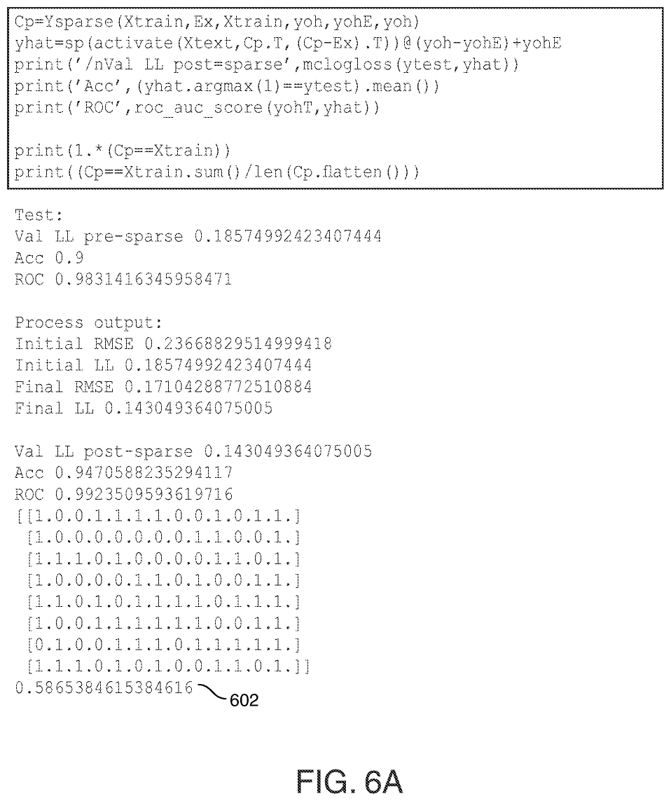

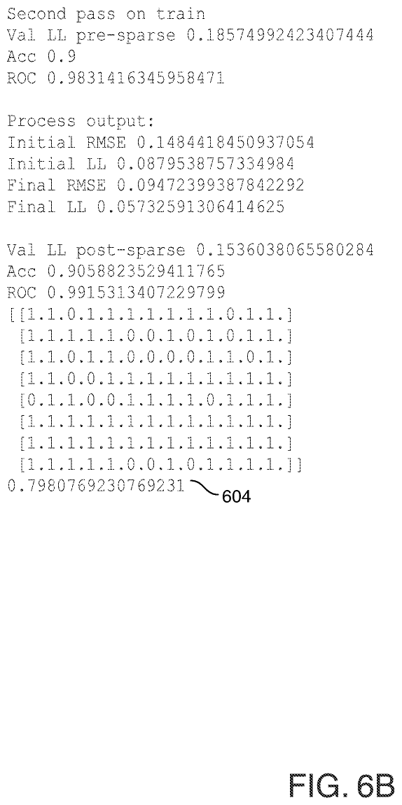

FIGS. 6A and 6B shows illustrative computer code. The illustrative computer code shows a test use case. The initial output produces an accuracy level of 0.5865, shown at 602. The accuracy level may correspond to the level in which the machine considers that the characterization output appropriately classifies the inputted data set.

The second output, following the X sparsification produces an accuracy level of 0.7980, shown at 604. As such, X sparsification increased the accuracy level from 0.5865 to 0.7980.

Thus, systems and methods for AI-based feature selection using cascaded model explanations is provided. Persons skilled in the art will appreciate that the present invention can be practiced by other than the described embodiments, which are presented for purposes of illustration rather than of limitation. The present invention is limited only by the claims that follow.

What is claimed is:

1. A method for harnessing an explainable artificial intelligence system to execute computer-aided feature selection, the method comprising:
receiving an AI-based model, said AI-based model being trained with a plurality of training data elements, said AI-based model identifying a plurality of features from the plurality of training data elements, said AI-based model executing with respect to a first input;
using a cascade of models with integrated gradients to identify a feature importance value for each of the plurality of features;
based on the feature importance value identified for each feature included in the plurality of features, determining a feature importance metric level;
based on the feature importance value identified for each feature included in the plurality of features, removing one or more features, from the plurality of features, that are assigned a feature importance value that is less than the feature importance metric level to form a revised AI-based model; and
executing the revised AI-based model with respect to a second input.

2. The method of claim 1, wherein the feature importance metric level corresponds to a percentage of the plurality of features.

3. The method of claim 1, wherein the feature importance metric level corresponds to a predetermined number of the plurality of features.

4. The method of claim 1, wherein the feature importance metric level corresponds to a predetermined value assigned to the plurality of features.

5. The method of claim 4, wherein the predetermined value corresponds to a negative value.

6. A method for harnessing an explainable artificial intelligence system to execute computer-aided feature selection, the method comprising:
on a first iteration:
receiving a characterization output characterizing a first data structure;
identifying a plurality of data elements associated with the first data structure;
feeding the plurality of data elements into one or more models;
processing the plurality of data elements at the one or more models;
identifying a plurality of outputs from the one or more models;
feeding the plurality of outputs into an event processor;
processing the plurality of outputs at the event processor;
grouping the plurality of outputs into a plurality of events at the event processor;
inputting the plurality of events into a determination processor;
determining, at the determination processor, a probability of the first data structure being associated with the characterization output;
in order to remove a predetermined number of data elements from the plurality of data elements, said predetermined number of data elements that are detrimental to the characterization output:
multiplying the integrated gradient of the determination processor with respect to the plurality of outputs by (the integrated gradient of the event processor with respect to the plurality of data elements divided by the plurality of outputs), which results in a vector of:
a subset of the plurality of data elements; and
a probability that each data element, included in the subset of data elements, contributed to the characterization output;
removing one or more data elements from the subset of the plurality of data elements that are associated with a probability that is less than a probability threshold to form an updated subset of the plurality of data elements;
on a second iteration:
re-feeding the updated subset of the plurality of data elements into the one or more models;
re-processing the plurality of data elements at the one or more models;
re-identifying the plurality of outputs from the one or more models;
re-feeding the plurality of outputs into the event processor;
re-processing the plurality of outputs at the event processor;
re-grouping the plurality of outputs into the plurality of events at the event processor;
re-inputting the plurality of events into the determination processor;
re-determining, at the determination processor, the probability of the first data structure being associated with the characterization output; and
utilizing the one or more models to characterize unlabeled data elements.

7. The method of claim 6, wherein the first iteration is re-executed until all of the data elements are assigned a probability that is greater than the probability threshold.

8. A method for harnessing an explainable artificial intelligence system to execute computer-aided feature selection, the method comprising:
on a first iteration:
receiving a characterization output characterizing a first data structure;
identifying a plurality of data elements associated with the first data structure;
feeding the plurality of data elements into one or more models;
processing the plurality of data elements at the one or more models;
identifying a plurality of outputs from one or more models;
determining a probability of the first data structure being associated with the characterization output;
in order to remove a predetermined number of data elements from the plurality of data elements, said predetermined number of data elements that are detrimental to the characterization output:
multiplying the integrated gradient of the one or more models with respect to the plurality of outputs by (the integrated gradient of the one or more models with respect to the plurality of data elements divided by the plurality of outputs), which results in a vector of:
a subset of the plurality of data elements; and
a probability that each data element, included in the subset of data elements, contributed to the characterization output;
removing one or more data elements from the subset of the plurality of data elements that are associated with a probability that is less than a probability threshold to generate an updated subset of the plurality of data elements;
on a second iteration:
re-feeding the updated subset of the plurality of data elements into the one or more models;
re-processing the plurality of data elements at the one or more models;
re-identifying the plurality of outputs from one or more models; and
utilizing the one or more models to characterize unlabeled data elements.

9. The method of claim 8, wherein the first iteration is re-executed until all of the data elements are assigned a probability that is greater than the probability threshold.

10. The method of claim 8, wherein an equation for determining the integrated gradient of the one or more models with respect to the plurality of outputs is:
$${IG}_{W} ( x ) = {\int }_{{t}_{0}}^{{t}_{f}} \frac{\partial W}{\partial x} \frac{d x}{d t} d t .$$

11. A computing resource conservation system comprising:
a priming model module operating on a hardware processor and a memory, the priming model module operable to:
receive a training data set, said training data set comprising a plurality of data element sets and a predetermined label associated with each of the data elements sets;
identify a plurality of features that characterize a data element set as being associated with the predetermined label;
create, using the plurality of features, an artificially-intelligent model that can characterize an unlabeled data element set as being associated with the predetermined label;
a refining model module operating on the hardware processor and the memory, the refining model module operable to:
assign, using an algorithm, a value to each feature included in the plurality of features;
remove, from the artificially-intelligent model, features that have been assigned a value that is less than a predetermined threshold to form a revised artificially-intelligent model; and
recreate the revised artificially-intelligent model that can characterize an unlabeled data element set as being associated with the predetermined label.

12. The computing resource conversation system of claim 11, wherein the algorithm is Integrated Gradients, Cascaded Integrated Gradients, SHAP or TreeSHAP.

13. The computing resource conservation system of claim 11, wherein the refining model module is re-executed until all of the features are assigned a value that is greater than the predetermined threshold.

14. The computing resource conservation system of claim 11, wherein the predetermined threshold is a percentage of the plurality of features.

15. The computing resource conservation system of claim 11, wherein the predetermined threshold corresponds to a predetermined number of the plurality of features.

16. The computing resource conservation system of claim 11, wherein the predetermined threshold corresponds to a predetermined value assigned to the plurality of features.

17. The computing resource conservation system of claim 16, wherein the predetermined threshold corresponds to a negative value.
